(19) United States
(12) Patent Application Publication
(10) Pub. No.: US 2008/0094303 A1
(43) Pub. Date: Apr. 24, 2008

(54) Planer inverted-F antenna device

(75) Inventors: Chieh-Lin Tseng, Gueishan Township (TW); Tz-Chang Liao, Gueishan Township (TW); Robert Chiang, Gueishan Township (TW); Jamie Yang, Gueishan Township (TW)

Correspondence Address: TROXELL LAW OFFICE PLLC, SUITE 1404, 5205 LEESBURG PIKE, FALLS CHURCH, VA, 22041, US

(73) Assignee: SPEED TECH CORP., Taoyuan County (TW)

(21) Appl. No.: 11/583,123

(22) Filed: Oct. 19, 2006

(51) Int. Cl. H01Q 1/48

(52) U.S. Cl. 343/848

(57) ABSTRACT

Planer inverted-F antennas are easily assembled into one device without diversity. The device diminishes interferences and polarization of the antenna to obtain high gain.

### FIELD OF THE INVENTION

The present invention relates to planer inverted-F antenna (PIFA); more particularly, relates to simplifying an assembling of the antenna and obtaining a high gain by reducing interruption of the antenna.

### DESCRIPTION OF THE RELATED ARTS

A general antenna is polarized. A so-called all-direction antenna is only an ante n n a with weak polarization. To avoid interferences owing to polarization on receiving signals by a wireless device, at least two antennas are extended out with diversity from a signal transferring device of the wireless device. The extended antennas are set at various places, or even are polarized to different directions, to reduce the interference owing to the polarization.

In another way, a metal conductive element is set around the PIFA to change an electronical characteristic or a frequency characteristic of a PIFA The metal conductive element itself is not an antenna, only to change the electronical characteristic or the frequency characteristic of the PIFA by electromagnetic induction between the metal conductive element and the antenna so that a radio characteristic of the antenna is enhanced and a limited space in an electronical device is well used to obtain a wider bandwidth for the antenna. Because it is useless to use the metal conductive element alone, the metal conductive element is called a parasitic element.

In FIG. 9, a U.S. patent is shown, called “Multi-band planar inverted-F antennas including floating parasitic elements and wireless terminals incorporating the same.” The prior art comprises a multi-band PIFA 7 and a floating parasitic element 71, where the multi-band PIFA 7 has two frequency bands. One is between 1710 and 1990 mega-hertz (MHz), which is extended from a first terminal 72 toward a second terminal 73. The other is between 824 and 894 MHz. Because the parasitic element 71 is isolated from the multi-band PIFA 7 without circuit connected, the parasitic element 71 is called a floating parasitic element. Although the floating parasitic element seems been isolated, the floating parasitic element and the multi-band PIFA 7 is related electromagnetically; especially, the second frequency band of the multi-band PIFA 7 is closely related to the floating parasitic element. By referring to FIG. 10, it is found that, when no floating parasitic element is used, a voltage standing wave ratio (VSWR) curve of the multi-band PIFA 7 is shown as the first curve 8. After the floating parasitic element is used, a new VSWR curve of the multi-band PIFA 7 is shown as the second curve 81. It is concluded that the floating parasitic element enhances the frequency bands of the multi-band PIFA 7. However, the prior art is still interfered by the polarization.

Moreover, a minimization in size and a maximization in function are both true to an electronical device now. The space for setting an antenna device in an electronical device is getting smaller, while the frequency bands of the antenna device is asked to be getting wider. But these two requirements are basically contradictive. Hence, the prior arts do not fulfill users' requests on actual use.

### SUMMARY OF THE INVENTION

The main purpose of the present invention is to have a base plate shared by and connected with three grounding plates of three antennas so that an antenna device is easily assembled without diversity, and interruption of the antenna device is reduced to obtain a high gain.

To achieve the above purpose, the present invention is a planer inverted-F antenna (PIFA) device, comprising a base plate; a first antenna at a side of an end of the base plate; a second antenna at a side in middle of the base plate; and a third antenna at a side of another end of the base plate, where the first, the second and the third antennas each has a grounding plate laterally connected at a side of the and a connecting plate connecting the grounding plate and the frequency plate. Accordingly, a novel PIFA device is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the perspective view of the preferred embodiment according to the present invention;

FIG. 2 is an other perspective view of the present invention;

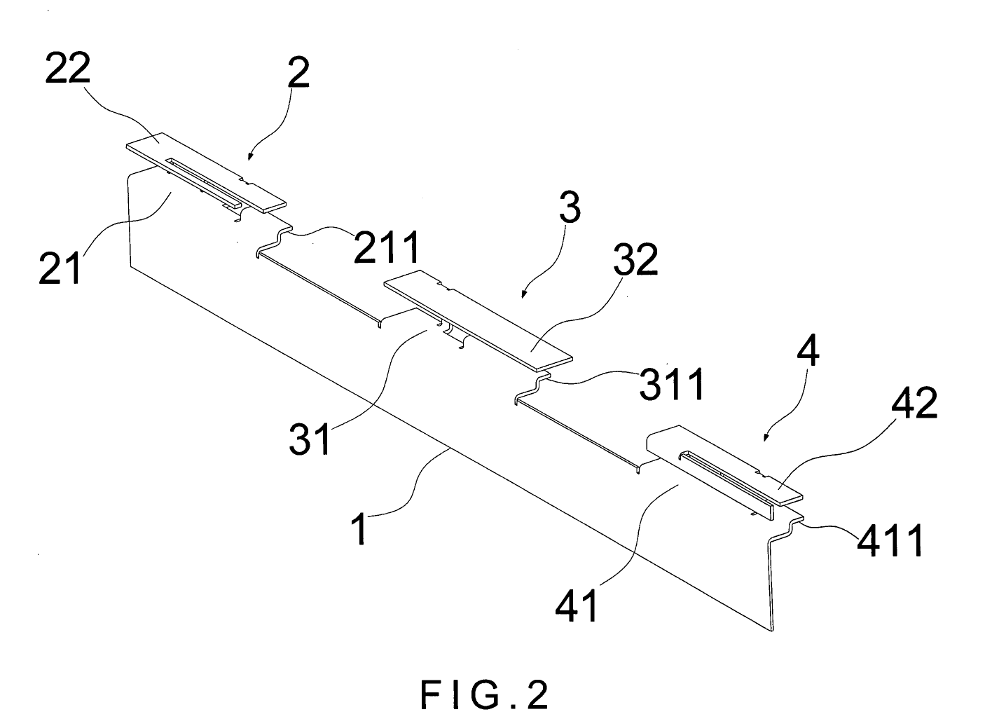

FIG. 3A is the view of the specifications of the present invention;

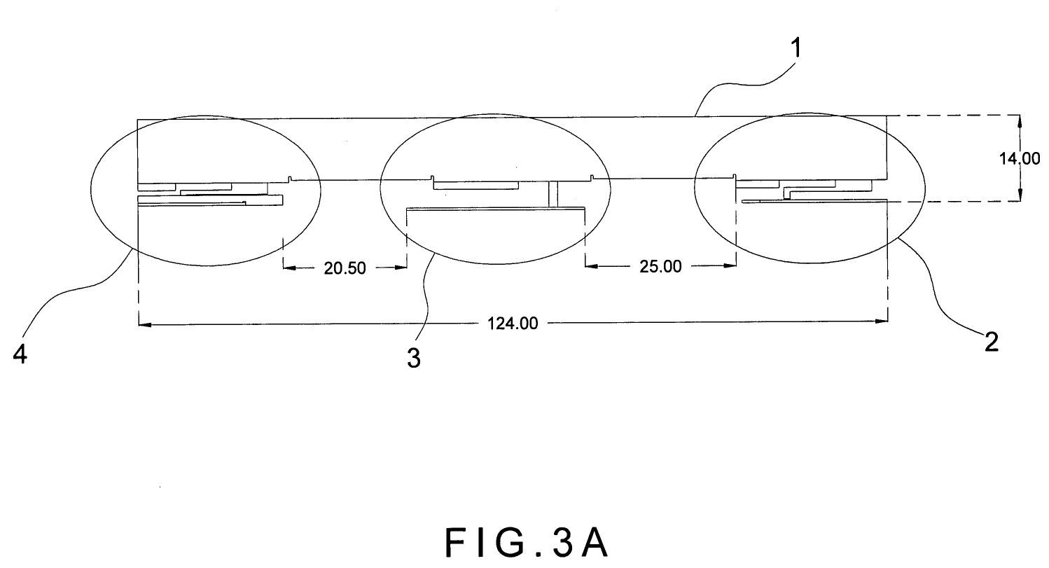

FIG. 3B is the view of the specifications of the first invention;

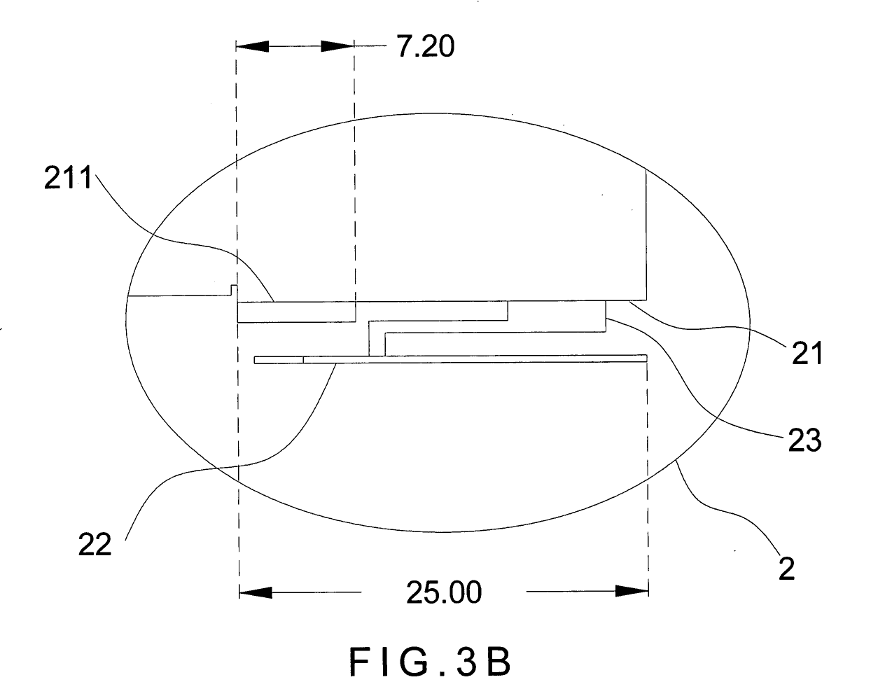

FIG. 3C is the view of the specifications of the first antenna;

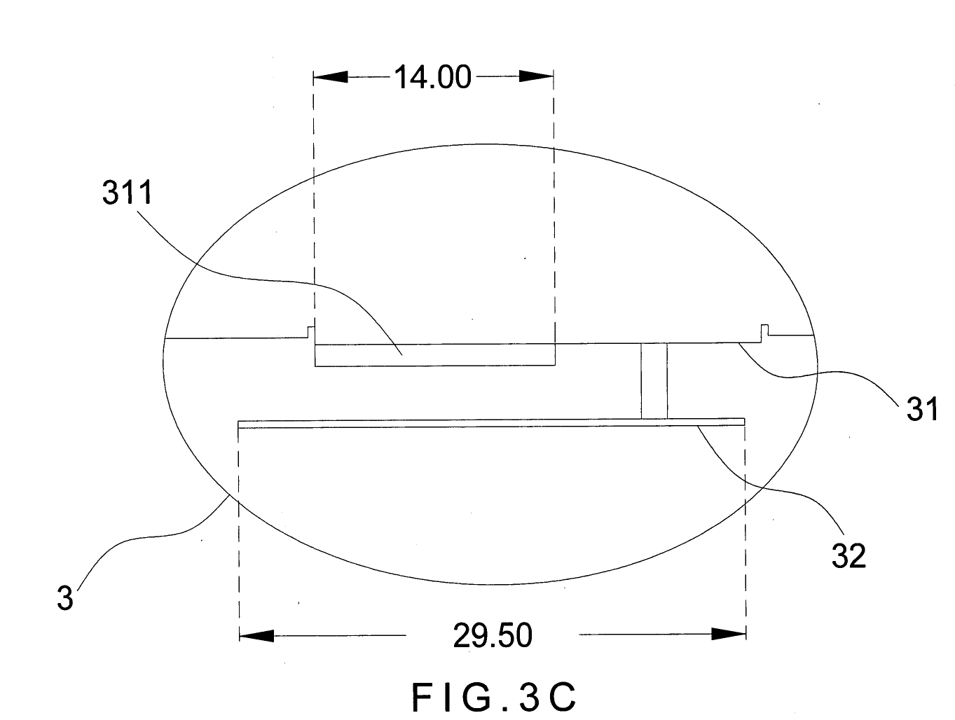

FIG. 3D is the view of the specifications of the first antenna;

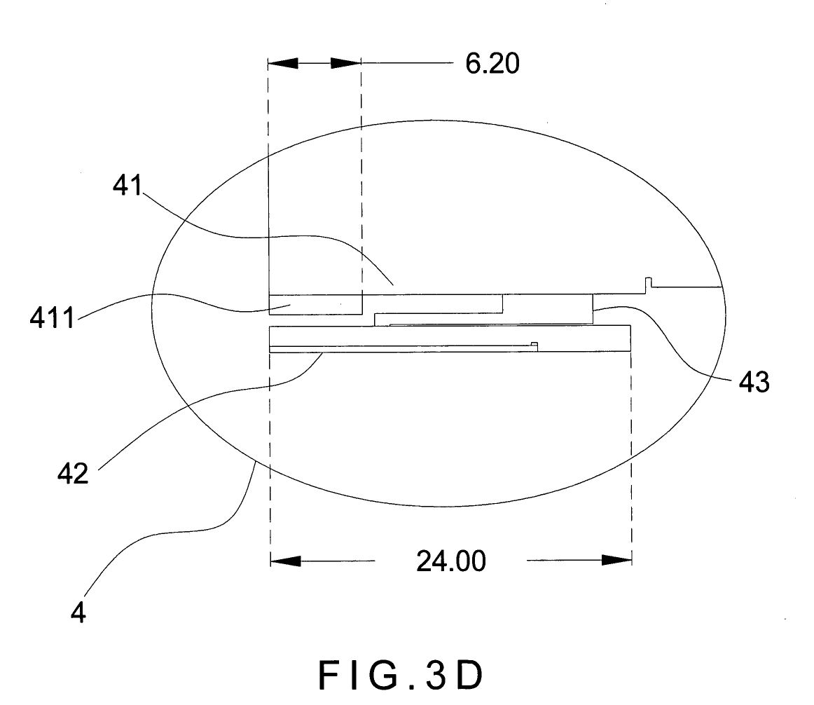

FIG. 4 is the view showing the state of assembly;

FIG. 5 is the view showing the state of use;

FIG. 6 is the view of the prior art; and

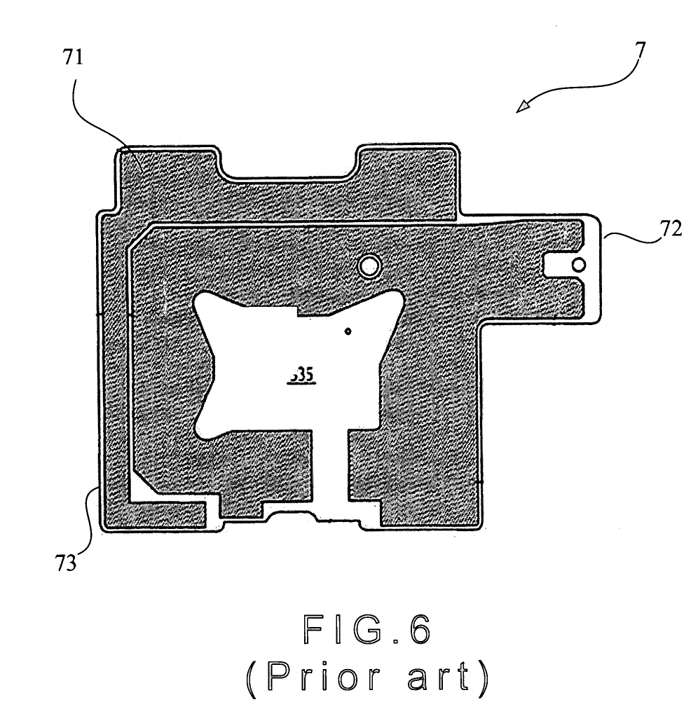

FIG. 7 is the VSWR view of the prior art.

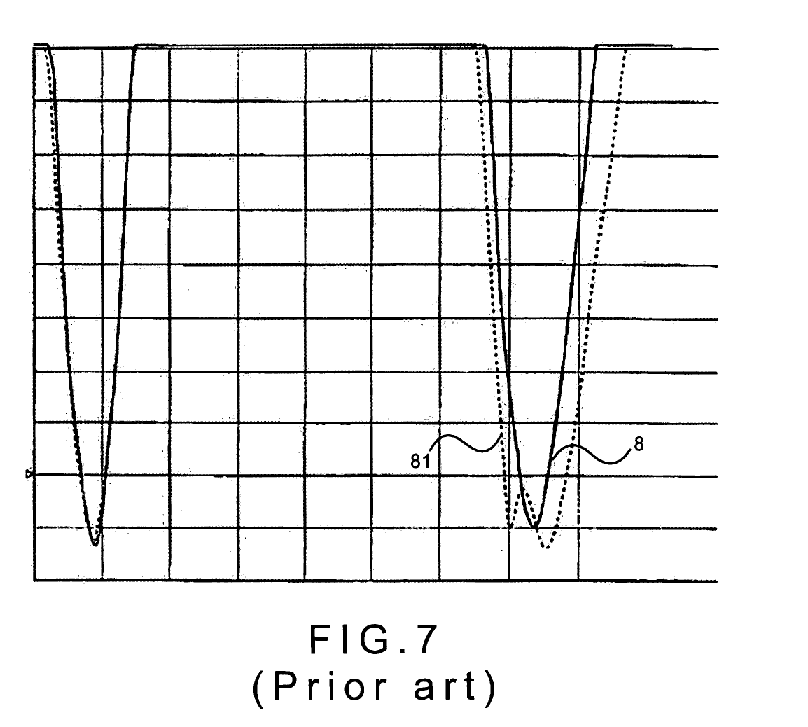

### DESCRIPTION OF THE PREFERRED EMBODIMENT

The following description of the preferred embodiment is provided to understand the features and the structures of the present invention.

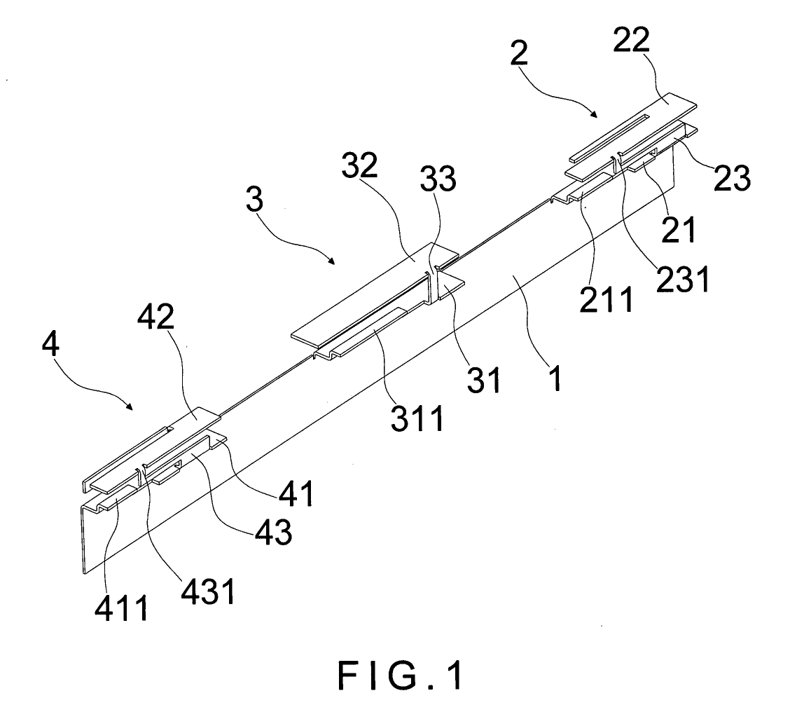

Please refer to FIG. 1, which is a perspective view of a preferred embodiment according to the present invention. As shown in the figure, the present invention is a planer inverted-F antenna (PIFA) device, comprising a baseplate 1, a first antenna 2, a second antenna 3 and a third antenna 4, where an assembling of an antenna device is simplified and interruption of the antenna device is reduced to obtain a high gain.

The base plate 1 is flat, whose length is 124 millimeters (mm); and the height of the base plate 1 together with antennas 2, 3, 4 is 14 mm.

The first antenna 2 comprises a first grounding plate 21 laterally being connected at a side of an end of the baseplate 1; a first frequency plate 22 corresponding to the first grounding plate 21; and a first connecting plate 23 connecting the first grounding plate 21 and the first frequency plate 22, where the first grounding plate 21 has a first grounding conductor 211; the first grounding conductor 211 has a length of 7.2 m m; the first frequency plate 22 has a length of 25 mm; and the first connecting plate 23 has a first feed-in conductor 231.

The second antenna 3 comprises a second grounding plate 31 being laterally connected at a side in middle of the base plate 1; a second frequency plate 32 corresponding to the second grounding plate 31; and a second connecting plate 33 connecting the second grounding plate 31 and the second frequency plate 32, where the second grounding plate 31 has a second grounding conductor 311; the second grounding conductor 311 has a length of 14 mm; and the second frequency plate 32 has a length of 29.5 mm.

The third antenna 4 comprises a third grounding plate 41 being laterally connected at a side of another end of the baseplate 1; a third frequency plate 42 corresponding, to the third grounding plate 41; and a third connecting plate 43 connecting the third grounding plate 41 and the third frequency plate 42, where the third grounding plate 41 has a third grounding conductor 411; the third grounding conductor 411 has a length of 6.2 mm; the third frequency plate 42 has a length of 24 mm; and the third connecting plate 43 has a second feed-in conductor 431.

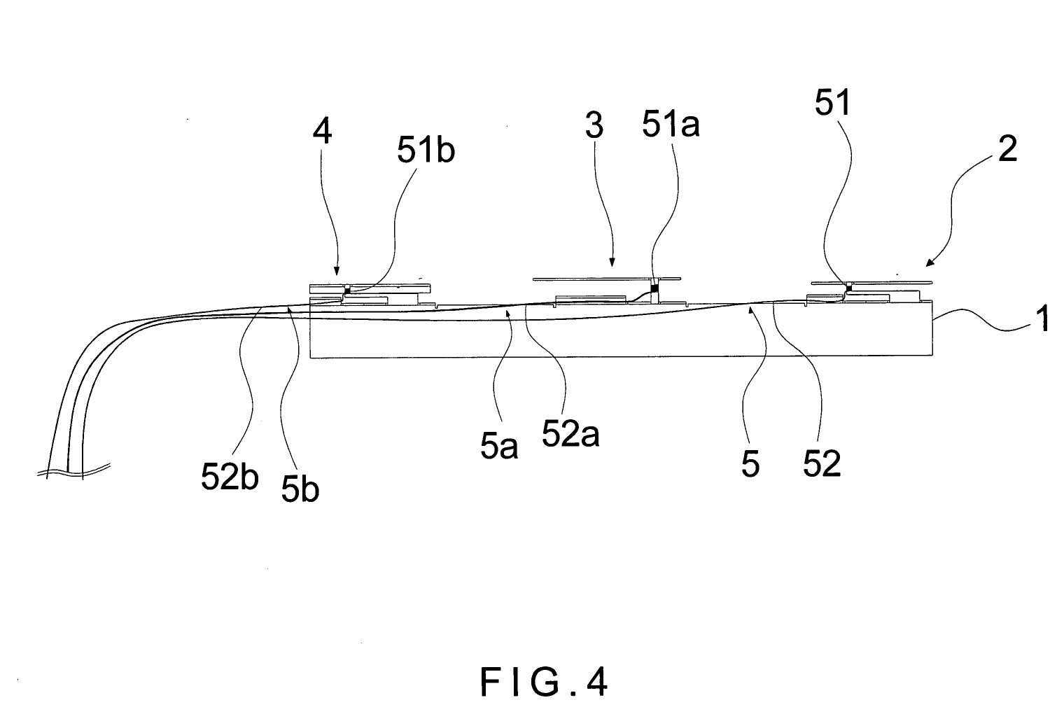

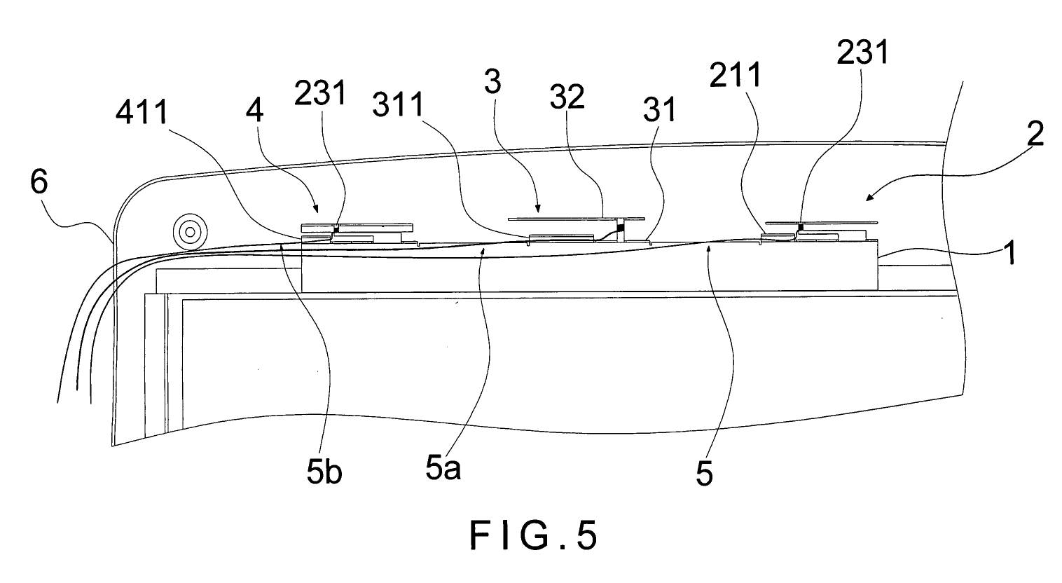

Please refer to FIG. 4 and FIG. 5, which are views showing a state of assembly and a state of use. As shown in the figures, when using the present invention, various coaxial leading wires 5, 5a, 5b are connected to the first, the second and the third antennas 2,3,4 respectively. The coaxial leading wires 5, 5a, 5b used in a mobile communication device 5, 5a, 5b comprises a central leading line 51, 51a, 51b and a braid metal shielding net 52, 52a, 52b respectively. The central leading line 51, 51a, 51b is used to transfer signals; and the braid metal shielding net 52, 52a, 52b is used to keep the line from interferences from outside.

When the first, the second and the third antennas 2, 3, 4 are connected with the various coaxial leading wires 5, 5a, 5b respectively, the central leading lines 51, 51a, 51b is fixed to the first feed-in conductor 231, the second frequency plate 32, and the second feed-in conductor 431 respectively; and the braid metal shielding nets 52, 52a, 52b are fixed to the first, the second and the third grounding conductors 211, 311, 411 respectively. And, then, the assembled antenna device is fixed on a proper place of an electronical device 6, such as a notebook computer.

The present invention has an acceptable interference from all directions; and the present invention receives signals having a frequency between 2.4 GHz and 2.5 GHz, whose isolation is acceptable. Hence, the present invention receives signals having a frequency between 2.4 GHz and 2.5 GHz without interference in between.

To sum up, the present invention is a PIFA device, where multiple antennas share and connect to the same base plate with grounding plates to obtain an antenna device without diversity so that an assembling of the antenna device is simplified and interruption of the antenna device is reduced to obtain a high gain.

The preferred embodiment herein disclosed is not intended to unnecessarily limit the scope of the invention. Therefore, simple modifications or variations belonging to the equivalent of the scope of the claims and the instructions disclosed herein for a patent are all with in the scope of the present invention.

What is claimed is:

1. A planer inverted-F antenna (PIFA) device, comprising:
a base plate;
a first antenna, said first antenna comprising a first grounding plate, a first frequency plate and a first connecting plate, said first grounding plate connecting at a side of an end of said base plate, said first frequency plate corresponding to said first grounding plate, said first connecting plate connecting said first grounding plate and said first frequency plate;
a second antenna, comprising a second grounding plate, a second frequency plate and a second connecting plate, said second grounding plate connecting at a side edge in middle of said baseplate, said second frequency plate corresponding to said second grounding plate, said second connecting plate connecting said second grounding plate and said second frequency plate; and a third antenna, said third antenna comprising a third grounding plate
a third frequency plate and a third connecting plate, said third grounding plate connecting at a side of another end of said base plate, said third frequency plate corresponding to said third grounding plate, said third connecting plate connecting said third grounding plate and said third frequency plate;

2. The PIFA device according to claim 1,
wherein said base plate has a length of 124 millimeters (mm); and
wherein said base plate with said first antenna, said second antenna and said third antenna has a height of 14 mm.

3. The PIFA device according to claim 1,
wherein said first grounding plate has a first grounding conductor.

4. The PIFA device according to claim 3,
wherein said first grounding conductor has a length of 7.2 mm.

5. The PIFA device according to claim 1,
wherein said first frequency plate has a length of 25 mm.

6. The PIFA device according to claim 1,
wherein first connecting plate has a first feed-in conductor.

7. The PIFA device according to claim 1,
wherein said second grounding plate has a second grounding conductor.

8. The PIFA device according to claim 7,
wherein said second grounding conductor has a length of 14 mm.

9. The PIFA device according to claim 1,
wherein said second frequency plate has a length of 29.5 mm.

10. The PIFA device according to claim 1,
wherein said third grounding plate has a third grounding conductor.

11. The PIFA device according to claim 10,
wherein said third grounding conductor has a length of 6.2 mm.

12. The PIFA device according to claim 1,
wherein said third frequency plate has a length of 24 mm.

13. The PIFA device according to claim 1,
wherein said third connecting plate has a second feed-in conductor.
